(19) United States
(12) Patent Application Publication
(10) Pub. No.: US 2023/0325352 A1
(43) Pub. Date: Oct. 12, 2023

(54) SYSTEMS AND METHODS FOR RACE FREE AND EFFICIENT SEGMENT CLEANING IN A LOG STRUCTURED FILE SYSTEM USING A B+ TREE METADATA STORE

(71) Applicant: VMware, Inc., Palo Alto, CA (US)

(72) Inventors: Quanxing LIU, Mountain View, CA (US); Wenguang WANG, Santa Clara, CA (US); Hardik Singh NEGI, Sunnyvale, CA (US); Maxime AUSTRUY, Pully (CH)

(21) Appl. No.: 17/658,133

(22) Filed: Apr. 6, 2022

(51) Int. Cl. G06F 16/16; G06F 12/02

(52) U.S. Cl. CPC G06F 16/164; G06F 12/0246; G06F 2212/7201

(57) ABSTRACT

A method for metadata updating is provided. The method generally includes identifying a first segment containing a first physical block corresponding to a first PBA where content of a first data block was previously stored, determining a first key associated with the first data block, wherein the first key comprises a block address in a first key-value pair that maps the block address to the first PBA, traversing a B+ tree to locate a node storing a second key-value pair that maps the first key to a second PBA, determining the second PBA and the first PBA match, and based on the determination: updating, in the second key-value pair, the second PBA to a third PBA corresponding to a second physical block where the content of the first data block is currently stored or removing, in the second key-value pair, the second PBA.

### BACKGROUND

Distributed storage systems allow multiple clients in a network to access a pool of shared resources. For example, a distributed storage system allows a cluster of host computers to aggregate local disks (e.g., solid state drive (SSD), peripheral component interconnect (PCI)-based flash storage, etc.) located in, or attached to, each host computer to create a single and shared pool of storage. This pool of storage (sometimes referred to herein as a “datastore” or “data storage”) is accessible by all host computers in the host cluster and may be presented as a single namespace of storage entities, such as a hierarchical file system namespace in the case of files, a flat namespace of unique identifiers in the case of objects, etc. Data storage clients in turn, such as virtual machines (VMs) spawned on the host computers, may use the datastore, for example, to store virtual disks.

Such datastores often use a write-optimized log-structured file system (LFS) data structures to store data in data blocks (e.g., physical blocks of storage, such as 4096 bytes or “4K” size blocks), for example, in one or more logs or segments (e.g., sequential portions of a virtual disk which contain a plurality of data blocks. Storing data using an LFS data structure significantly reduces write amplification, such as in situations where the storage system that is used to store the data does not allow for data overwrites. Write amplification may refer to a ratio of the size of the actual data written to a storage versus the size of data that is requested by a write operation to be written to the storage. As new data (e.g., in new segments) are continuously added to the datastore, a segment cleaning mechanism may be needed to recycle the dead space (e.g., one or more dead data blocks in one or more segments that deleted or modified data occupies).

In a conventional segment cleaning approach, a segment is read into memory and all data blocks in the segment are examined to determine which blocks of the segment are live data blocks (or live blocks). Subsequently, live data blocks of the segment may be written out to a new segment (e.g., along with other live blocks), and the old segment may be marked as dead or invalid (e.g., such that new data in the future may be written to data blocks in this segment). After data is written to one or more segments (e.g., as one or more data blocks), some portions of the data may be modified (e.g., changed or deleted). When the data is changed, one or more data blocks of the data that is changed may be written to one or more new segments of an LFS data structure. As such, the old data block(s) for which new data block(s) are added to the LFS data structure, or which are deleted, may be referred to as dead data blocks (or dead blocks). Conversely, other data blocks of a segment that are not dead (e.g., that still contain valid data) may be referred to as live data blocks.

Since the location of the live data blocks are moved to new physical addresses (e.g., associated with the new segment(s)) during segment cleaning, all metadata pointing to the live data blocks may be required to be changed to point to the new physical addresses of the blocks. For example, a logical map table may include the logical block addresses (LBAs) of the data blocks (e.g., defined in a logical address space) mapped to physical block addresses (PBAs) of the data blocks (e.g., defined in a physical address space). After identifying and moving the live blocks, the segment cleaning process may need to update the entries of all moved blocks in the logical map table to map the LBAs for these blocks to their new PBAs.

The metadata (e.g., the LBA to PBA mappings) may be stored as key-value data structures to allow for scalable input/output (I/O) operations. In particular, a unified logical map B+ tree may be used to manage logical extents for the logical address to physical address mappings, where an extent is a specific number of contiguous data blocks allocated for storing information. A B+ tree is a multi-level data structure having a plurality of nodes, each node containing one or more key-value pairs stored as tuples (e.g., <key, value>). A key is an identifier of data and a value is either the data itself or a pointer to a location (e.g., in memory or on disk) of the data associated with the identifier. Accordingly, one or more key-value pairs in the B+ tree data structure may need to be updated as live data blocks are moved during segment cleaning in the LFS data structure.

Unfortunately, often there is more than one source of I/O that has access to read and/or modify metadata stored as key-value pairs in the B+ tree. For example, basic system I/O operations in connection with data requests, such as data read and write operations, may also read and/or modify the metadata. Unfortunately, in some cases, while conventional segment cleaning is ongoing, as described above, an issued I/O may modify the data in a segment being cleaned and accordingly, update the metadata associated with the modified data. This issued user I/O may complete while segment cleaning is still occurring. Accordingly, this may result in an undesirable race condition. A race condition occurs when a device or system attempts to perform two or more operations at the same time, but because of the nature of the device or system, the operations must be done in the proper sequence to be done correctly. In the segment cleaning, the race condition occurs when a received I/O modifies data in a segment being cleaned and updates the metadata for this data stored as key-value pairs in the B+ tree during segment cleaning and, more specifically, before updating the metadata for live data blocks moved during segment cleaning. Accordingly, in this case, segment cleaning may be said to have “lost” the race to the user I/O. Such race conditions may lead to inconsistent or corrupt metadata. Accordingly, techniques for efficient and race free segment cleaning may be desired.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 is a diagram illustrating an example computing environment in which embodiments of the present application may be practiced.

FIG. 2 is a diagram illustrating an embodiment in which a datastore module receives a data block and stores the data in the data block in different memory layers of a hosting system, according to an example embodiment of the present disclosure.

FIG. 3A is a diagram illustrating example segment cleaning used to consolidate live data blocks, according to an example embodiment of the present disclosure.

FIGS. 3B and 3C illustrate example metadata mapping which may be used during segment cleaning, according to an example embodiment of the present disclosure.

FIG. 4 is a diagram illustrating an example two-layer extent mapping architecture, according to an example embodiment of the present disclosure.

FIG. 5A is a diagram illustrating a B+ tree data structure storing logical map key-value pairs, according to an example embodiment of the present disclosure.

FIG. 5B is a diagram illustrating a B+ tree data structure storing middle map key-value pairs, according to an example embodiment of the present disclosure.

FIG. 6 is an example workflow for metadata updating during segment cleaning, according to an example embodiment of the present disclosure.

### DETAILED DESCRIPTION

Aspects of the present disclosure introduce techniques for achieving race free and efficient segment cleaning in a log structured file system.

As mentioned, segment cleaning may result in the update or removal of metadata for one of more data blocks. In certain aspects, more than one source of input/output (I/O) may modify the metadata for the one or more data blocks. Accordingly, in some cases, one source of I/O may modify data and update its corresponding metadata that is also being segment cleaned prior to completion of the segment cleaning process (e.g., prior to metadata updates for live data blocks moved to new segments). Accordingly, segment cleaning may “lose” the race to update the metadata for the same data modified by the user I/O. If such I/Os are not handled properly, the race condition may lead to inconsistent or corrupt metadata stored for one or more data blocks. As an illustrative example, in some cases, each data block may include its own metadata, e.g., mapping of its corresponding LBA mapped to a PBA where the data block is written, which may be stored concurrently by several compute nodes (e.g., metadata servers). In particular, the metadata may be stored as key-value data structures to allow for scalable I/O operations. A B+ tree may be used to manage such key-value mappings, such that a schema of the B+ tree includes tuples of <LBA, PBA>, where the LBA is the key.

As mentioned, key-value mappings stored in the B+ tree may need to be updated, or removed, to maintain consistent metadata mappings where one or more data blocks are moved to new physical addresses (e.g., associated with the new segment(s)) during segment cleaning. However, in some cases, prior to updating the metadata, but after commencing the write out of live data blocks to the new segment, a user issues an I/O for writing, deleting, or updating one or more of the live data blocks being written. The I/O may cause metadata for the one or more data blocks, which are (e.g., a key-value pair) requested to be updated and stored in the B+ tree, to be modified. Segment cleaning may also seek to modify the same metadata as the I/O. Processing of the I/O prior to completing the segment cleaning process may lead to a race condition between the I/O issued by the user and the segment cleaning process. In particular, where segment cleaning modifies key-value pairs for live data blocks written to the new segment after the user I/O is complete, the key-value pair may point to stale or invalid data and user data (e.g., modified or added by the I/O) may be lost by the subsequent update.

Locks may be used to keep nodes storing key-value pairs in the B+ tree locked while one source of I/O is modifying the metadata, such that only one source of I/O has the ability to modify the locked metadata at one time. Generally, an algorithm of the B+ tree (also referred to herein as B+ tree code) may be used to determine which nodes in the B+ tree are to be locked when an update is to occur; thus, there may be no external control over which nodes of the B+ tree may be locked, or may not be locked. Accordingly, to ensure only one source of I/O can modify multiple B+ tree nodes to avoid a race condition, the entire B+ tree may be locked (e.g., a lock outside of the B+ tree may be set to lock the entire B+ tree). Locking the entire B+ tree may ensure that a race condition is avoided, especially in cases where metadata (e.g., key-value mappings) to be updated is spread across multiple nodes in the B+ tree, by preventing other I/Os from modifying any metadata stored at any node in the B+ tree. Given segment cleaning may, in some cases, be a time consuming process, other I/Os may experience increased latency. In particular, during the time from when the segment cleaning process begins (e.g., when the B+ tree is locked) and when the segment cleaning process ends (e.g., when locks are removed), other I/Os, such as metadata lookups, write I/Os, snapshot processing, etc., may not proceed, and thus adversely affect the performance of the system.

Accordingly, techniques presented herein propose the use of “compare and set” and “compare and remove” application programming interfaces (APIs) to solve this race condition. “Compare and set” APIs may be used to compare current values with expected values and replace (e.g., “set”) the current values with new values where the current values and expected values match. “Compare and remove” APIs may be used to compare current values with expected values and remove the current values where the current values and expected values match. In particular, aspects described herein solve the race condition by first establishing that an expected value (e.g., an expected PBA) for a key stored in the B+ tree for a data block matches a previously recorded value for the key, stored within a segment. Where the “compare and set” or “compare and remove” APIs cannot confirm the expected and recorded values for the same key match, no updates to the metadata for segment cleaning may be performed, and segment cleaning processes may be retried. On the other hand, where the “compare and set” or “compare and remove” APIs are able to confirm the expected and recorded values for the same key match, updates to the metadata for segment cleaning may be performed. Accordingly, the integrity and consistency of data stored in the B+ tree may be maintained.

Further, aspects described herein leverage granular locking and retry mechanisms to maintain the integrity of metadata stored for data blocks in the B+ tree, while overcoming the challenges of I/O latency present when locking multiple B+ tree nodes for metadata updating.

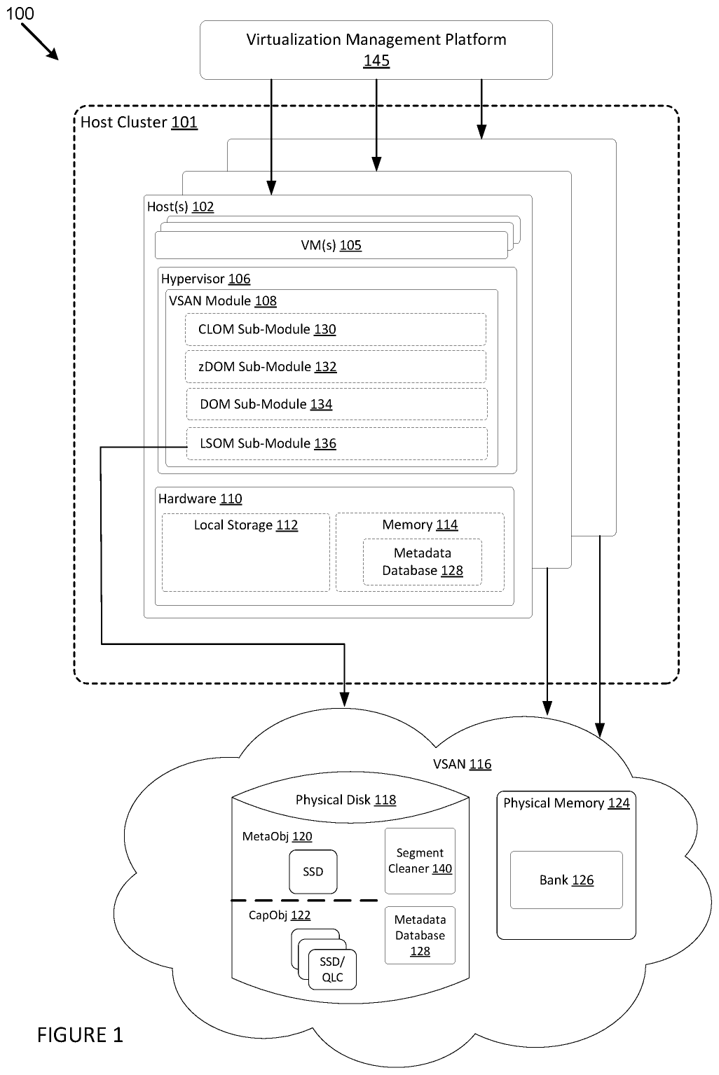

FIG. 1 is a diagram illustrating an example computing environment 100 in which embodiments may be practiced. As shown, computing environment 100 may include a distributed object-based datastore, such as a software-based “virtual storage area network” (VSAN) 116 environment that leverages the commodity local storage housed in or directly attached (hereinafter, use of the term “housed” or “housed in” may be used to encompass both housed in or otherwise directly attached) to host(s) 102 of a host cluster 101 to provide an aggregate object storage to virtual machines (VMs) 105 running on the host(s) 102. The local commodity storage housed in the hosts 102 may include combinations of solid state drives (SSDs) or non-volatile memory express (NVMe) drives, magnetic or spinning disks or slower/cheaper SSDs, or other types of storages

Additional details of VSAN are described in U.S. Pat. No. 10,509,708, the entire contents of which are incorporated by reference herein for all purposes, and U.S. patent application Ser. No. 17/181,476, the entire contents of which are incorporated by reference herein for all purposes.

VSAN 116 may manage storage of virtual disks at a block granularity. For example, VSAN 116 may be divided into a number of physical blocks (e.g., 4096 bytes or “4K” size blocks), each physical block having a corresponding PBA that indexes the physical block in storage. Physical blocks of VSAN 116 may be used to store blocks of data (also referred to as data blocks) used by VMs 105, which may be referenced by logical block addresses (LBAs). Each block of data may have an uncompressed size corresponding to a physical block. Blocks of data may be stored as compressed data or uncompressed data in VSAN 116, such that there may or may not be a one to one correspondence between a physical block in VSAN and a data block referenced by a logical block address. As used herein, an “object” in VSAN 116, for a specified data block, may be created by backing it with physical storage resources of a physical disk 118 (e.g., based on a defined policy).

VSAN 116 may be a two-tier datastore, thereby storing the data blocks in both a smaller, but faster, performance tier and a larger, but slower, capacity tier. The data in the performance tier may be stored in a first object (e.g., a data log that may also be referred to as a MetaObj 120) and when the size of data reaches a threshold, the data may be written to the capacity tier (e.g., in full stripes, wherein a full stripe write refers to a write of data blocks that fill a whole stripe) in a second object (e.g., CapObj 122) in the capacity tier. Accordingly, SSDs may serve as a read cache and/or write buffer in the performance tier in front of slower/cheaper SSDs (or magnetic disks) in the capacity tier to enhance I/O performance. In some embodiments, both performance and capacity tiers may leverage the same type of storage (e.g., SSDs) for storing the data and performing the read/write operations. Additionally, SSDs may include different types of SSDs that may be used in different tiers in some embodiments. For example, the data in the performance tier may be written on a single-level cell (SLC) type of SSD, while the capacity tier may use a quad-level cell (QLC) type of SSD for storing the data.

In certain embodiments, VSAN 116 includes a segment cleaner 140. Segment cleaner 140 may be configured to examine segments loaded in memory to identify live data blocks in the segment, write out identified live data blocks to new segment(s), and update metadata associated with the live data blocks written to new physical block locations. As described in more detail below, segment cleaner module 140 may also be configured to determine whether an expected PBA for a data block matches a PBA stored in a key-value mapping for the data block prior to updating the PBA stored in the key-value mapping. As used herein, the expected PBA may be a PBA of a data block in a previous segment where the data block was stored, prior to segment cleaning. In certain embodiments, segment cleaner 140 may be a process module in VSAN 116, while in certain other embodiments, segment cleaner 140 is a thread (e.g., a small set of instructions designed to be scheduled and executed).

As further discussed below, each host 102 may include a storage management module (referred to herein as a VSAN module 108) in order to automate storage management workflows (e.g., create objects in MetaObj 120 and CapObj 122 of VSAN 116, etc.) and provide access to objects (e.g., handle I/O operations to objects in MetaObj 120 and CapObj 122 of VSAN 116, etc.) based on predefined storage policies specified for objects in physical disk 118. For example, because a VM 105 may be initially configured by an administrator to have specific storage requirements for its “virtual disk” depending on its intended use (e.g., capacity, availability, I/O operations per second (IOPS), etc.), the administrator may define a storage profile or policy for each VM specifying such availability, capacity, IOPS and the like.

A virtualization management platform 145 is associated with host cluster 101. Virtualization management platform 145 enables an administrator to manage the configuration and spawning of VMs 105 on various hosts 102. As illustrated in FIG. 1, each host 102 includes a virtualization layer or hypervisor 106, a VSAN module 108, and hardware 110 (which includes the storage (e.g., SSDs) of a host 102). Through hypervisor 106, a host 102 is able to launch and run multiple VMs 105. Hypervisor 106, in part, manages hardware 110 to properly allocate computing resources (e.g., processing power, random access memory (RAM), etc.) for each VM 105. Furthermore, as described below, each hypervisor 106, through its corresponding VSAN module 108, provides access to storage resources located in hardware 110 (e.g., storage) for use as storage for virtual disks (or portions thereof) and other related files that may be accessed by any VM 105 residing in any of hosts 102 in host cluster 101.

In one embodiment, VSAN module 108 may be implemented as a “VSAN” device driver within hypervisor 106. In such an embodiment, VSAN module 108 may provide access to a conceptual “VSAN” through which an administrator can create a number of top-level “device” or namespace objects that are backed by the physical disk 118 of VSAN 116. By accessing application programming interfaces (APIs) exposed by VSAN module 108, hypervisor 106 may determine all the top-level file system objects (or other types of top-level device objects) currently residing in VSAN 116.

A file system object may, itself, provide access to a number of virtual disk descriptor files accessible by VMs 105 running in host cluster 101. These virtual disk descriptor files may contain references to virtual disk “objects” that contain the actual data for the virtual disk and are separately backed by physical disk 118. A virtual disk object may itself be a hierarchical, “composite” object that is further composed of “component” objects that reflect the storage requirements (e.g., capacity, availability, IOPs, etc.) of a corresponding storage profile or policy generated by the administrator when initially creating the virtual disk. Each VSAN module 108 (through a cluster level object management or “CLOM” sub-module 130) may communicate with other VSAN modules 108 of other hosts 102 to create and maintain an in-memory metadata database 128 (e.g., maintained separately but in synchronized fashion in memory 114 of each host 102) that may contain metadata describing the locations, configurations, policies and relationships among the various objects stored in VSAN 116. Specifically, in-memory metadata database 128 may serve as a directory service that maintains a physical inventory of the VSAN 116 environment, such as the various hosts 102, the storage resources in hosts 102 (SSD, NVMe drives, magnetic disks, etc.) housed therein and the characteristics/capabilities thereof, the current state of hosts 102 and their corresponding storage resources, network paths among hosts 102, and the like. The in-memory metadata database 128 may further provide a catalog of metadata for objects stored in MetaObj 120 and CapObj 122 of VSAN 116 (e.g., what virtual disk objects exist, what component objects belong to what virtual disk objects, which hosts 102 serve as “coordinators” or “owners” that control access to which objects, quality of service requirements for each object, object configurations, the mapping of objects to physical storage locations, etc.).

In-memory metadata database 128 is used by VSAN module 108 on host 102, for example, when a user (e.g., an administrator) first creates a virtual disk for VM 105 as well as when VM 105 is running and performing I/O operations (e.g., read or write) on the virtual disk.

Various sub-modules of VSAN module 108, including, in some embodiments, CLOM sub-module 130, distributed object manager (DOM) sub-module 134, zDOM sub-module 132, and/or local storage object manager (LSOM) sub-module 136, handle different responsibilities. CLOM sub-module 130 generates virtual disk blueprints during creation of a virtual disk by a user (e.g., an administrator) and ensures that objects created for such virtual disk blueprints are configured to meet storage profile or policy requirements set by the user.

In some cases, the storage policy may define attributes such as a failure tolerance, which defines the number of host and device failures that a VM can tolerate. In some embodiments, a redundant array of inexpensive disks (RAID) configuration may be defined to achieve desired redundancy through mirroring and access performance through erasure coding (EC). EC is a method of data protection in which each copy of a virtual disk object is partitioned into stripes, expanded and encoded with redundant data pieces, and stored across different hosts 102 of VSAN 116. For example, a virtual disk blueprint may describe a RAID 1 configuration with two mirrored copies of the virtual disk (e.g., mirrors) where each are further striped in a RAID 0 configuration. Each stripe may contain a plurality of data blocks. In some cases, including RAID 5 and RAID 6 configurations, each stripe may also include one or more parity blocks. Accordingly, CLOM sub-module 130, in one embodiment, may be responsible for generating a virtual disk blueprint describing a RAID configuration.

CLOM sub-module 130 may communicate the blueprint to its corresponding DOM sub-module 134, for example, through zDOM sub-module 132. DOM sub-module 134 may interact with objects in VSAN 116 to implement the blueprint by, for example, allocating or otherwise mapping component objects of the virtual disk object to physical storage locations within various hosts 102 of host cluster 101. DOM sub-module 134 may also access the in-memory metadata database 128 to determine the hosts 102 that store the component objects of a corresponding virtual disk object and the paths by which those hosts 102 are reachable in order to satisfy the I/O operation.

Each DOM sub-module 134 may need to create their respective objects, allocate local storage 112 to such objects (if needed), and advertise their objects in order to update in-memory metadata database 128 with metadata regarding the object. In order to perform such operations, DOM sub-module 134 may interact with a local storage object manager (LSOM) sub-module 136 that serves as the component in VSAN module 108 that may actually drive communication with the local SSDs (and, in some cases, magnetic disks) of its host 102. In addition to allocating local storage 112 for virtual disk objects (as well as storing other metadata, such as policies and configurations for composite objects for which its node serves as coordinator, etc.), LSOM sub-module 136 may additionally monitor the flow of I/O operations to local storage 112 of its host 102, for example, to report whether a storage resource is congested.

zDOM sub-module 132 may be responsible for caching received data in the performance tier of VSAN 116 (e.g., as a virtual disk object in MetaObj 120) and writing the cached data as full stripes on one or more disks (e.g., as virtual disk objects in CapObj 122). For example, an I/O request to write a block of data may be received by VSAN module 108, and through zDOM sub-module 132 of VSAN module 108, the data may be stored in a physical memory 124 (e.g., a bank 126) and a data log of the VSAN's performance tier first, the data log being stored over a number of physical blocks. Once the size of the stored data in the bank reaches a threshold size, the data stored in the bank may be flushed to the capacity tier (e.g., CapObj 122) of VSAN 116. zDOM sub-module 132 may do full stripe writing to minimize a write amplification effect. Write amplification, refers to the phenomenon that occurs in, for example, SSDs, in which the amount of data written to the memory device is greater than the amount of information you requested to be stored by host 102. Lower write amplification may increase performance and lifespan of an SSD.

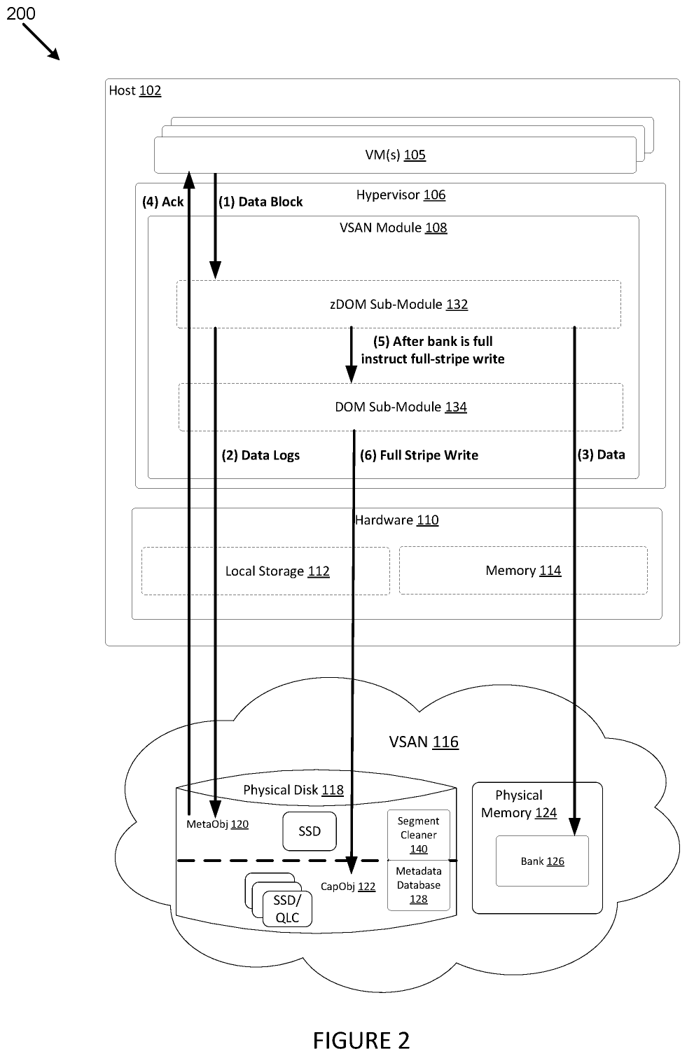

FIG. 2 is a diagram illustrating an embodiment in which VSAN module 108 receives a data block and stores the data in the data block in different memory layers of VSAN 116, according to an example embodiment of the present application.

As shown in FIG. 2, at (1), zDOM sub-module 132 receives a data block from VM 105. At (2), zDOM sub-module 132 instructs DOM sub-module 134 to preliminarily store the data received from the higher layers (e.g., from VM 105) in a data log (e.g., also referred to herein as the MetaObj 120) of the performance tier of VSAN 116 and, at (3), in physical memory 124 (e.g., bank 126).

zDOM sub-module 132 may compress the data in the data block into a set of one or more sectors (e.g., each sector being 512-byte) of one or more physical disks (e.g., in the performance tier) that together store the data log. zDOM sub-module 132 may write the data blocks in a number of physical blocks (or sectors) and write metadata (e.g., the sectors' sizes, snapshot id, block numbers, checksum of blocks, transaction id, etc.) about the data blocks to the data log maintained in MetaObj 120. In some embodiments, the data log in MetaObj 120 includes a set of one or more records, each having a header and a payload for saving, respectively, the metadata and its associated set of data blocks. As shown in FIG. 2, after the data (e.g., the data blocks and their related metadata) is written to MetaObj 120 successfully, then at (4), an acknowledgement is sent to VM 105 letting VM 105 know that the received data block is successfully stored.

In some embodiments, when bank 126 is full (e.g., reaches a threshold capacity that satisfies a full stripe write), then at (5), zDOM sub-module 132 instructs DOM sub-module 134 to flush the data in bank 126 to perform a full stripe write to CapObj 122. At (6), DOM sub-module 134 writes the stored data in bank 126 sequentially on a full stripe (e.g., the whole segment or stripe) to CapObj 122 in physical disk 118.

zDOM sub-module 132 may further instruct DOM sub-module 134 to flush the data stored in bank 126 onto one or more disks (e.g., of one or more hosts 102) when the bank reaches a threshold size (e.g., a stripe size for a full stripe write). The data flushing may occur, while a new bank (not shown in FIG. 2) is allocated to accept new writes from zDOM sub-module 132. The number of banks may be indicative of how many concurrent writes may happen on a single MetaObj 120.

After flushing in-memory bank 126, zDOM sub-module 132 may release (or delete) the associated records of the flushed memory in the data log. This is because when the data stored in the bank is written to CapObj 122, the data is in fact stored on one or more physical disks (in the capacity tier) and there is no more need for storing (or keeping) the same data in the data log of MetaObj 120 (in the performance tier). Consequently, more free space may be created in the data log for receiving new data (e.g., from zDOM sub-module 132).

In order to write a full stripe (or a full segment), VSAN module 108 may always write the data stored in bank 126 on sequential blocks of a stripe. As such, notwithstanding what the LBAs of a write are, the PBAs (e.g., on the physical disks) may always be continuous for the full stripe write.

Due to design issues and the limited number of writes allowed by memory cells of SSDs, an overwrite operation (e.g., a write for a data block referenced by an LBA that previously had written data associated with the LBA) may require that data previously associated with an LBA, for which new data is requested to be written, be erased before new content can be written (e.g., due to program/erase (P/E) cycles of the SSD). Erase operations may be block-wise. Therefore, data may be modified (i.e., written) only after the whole data block to which it prior belonged is erased, which makes write operations significantly more costly than reads in terms of performance and energy consumption of the SSD. As is known in the art, a better alternative, as opposed to erasing a data block each time new content is to be written for an LBA, may include marking an old data block (containing the unchanged data) as “dead” (e.g., invalid or not active) and then writing the new, changed data to an empty data block. Invalid blocks may be garbage collected at a later time. While this may delay issuing erase operations thereby prolonging the lifespan of an SSD, stripes may become fragmented as the number of invalid blocks increases with each overwrite.

In order to provide clean segments (e.g., stripes) for zDOM sub-module 132 full stripe writes, segment cleaning may be introduced to recycle segments partially filled with “live” data blocks and move such live data block(s) to new location(s) (e.g., new segment(s)). Segment cleaning consolidates fragmented free space to improve write efficiency. To free-up or clean selected segments, extents of the segments that contain live data may be moved to different clean segments, and the selected segments (now clean) may be freed for subsequent reuse. Once a segment is cleaned and designated freed, data may be written sequentially to that segment. Selection of a clean segment to receive data (i.e., writes) from a segment being cleaned may be based, in some cases, upon an amount of free space (e.g., free data blocks) remaining in the clean segment. Portions of data from the segment being cleaned may be moved to different “target” segments. That is, a plurality of relatively clean segments may receive differing portions of data from the segment(s) being cleaned.

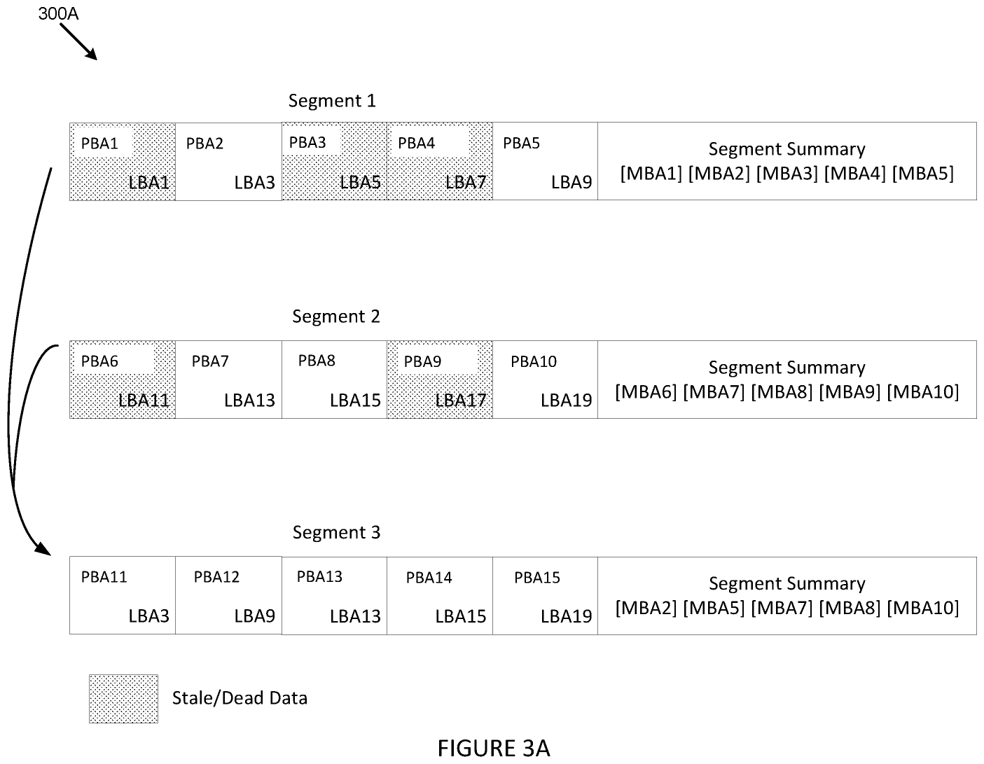

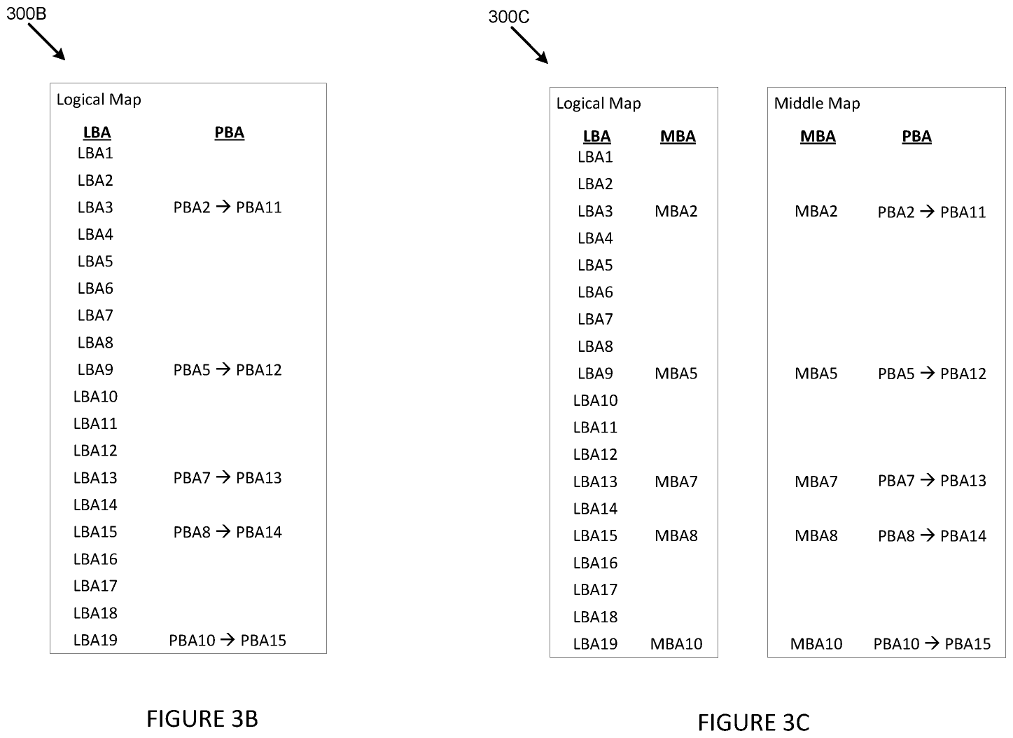

FIG. 3A is a diagram 300 illustrating example segment cleaning used to consolidate live data blocks, according to an example embodiment of the present disclosure. FIGS. 3B and 3C illustrate example metadata mapping 300B and 300C, respectively, which may be used during segment cleaning, according to an example embodiment of the present disclosure. As shown in the example of FIG. 3A, live (e.g., active) data blocks from two segments, Segment 1 and Segment 2, may be consolidated into a new segment, Segment 3. As described above, the segments may include dead (e.g., inactive) data blocks, due to, for example, one or more overwrites of data for one or more LBAs.

Segment 1 may include data blocks associated with PBAs 1 through 5, Segment 2 may include data blocks associated with PBAs 6 through 10, and Segment 3 may include data blocks associated with PBAs 11 through 15. In the illustrated example, two data blocks, associated with PBA2 and PBA5, are live data blocks in Segment 1 while three data blocks, associated with PBA1, PBA3, and PBA4, are dead data blocks (shown as patterned blocks) containing stale data in Segment 1. Similarly, three data blocks, associated with PBA7, PBA8, and PBA10, are live data blocks in Segment 2 while two data blocks, associated with PBA6 and PBA9, are dead data blocks (shown as patterned blocks) containing stale data in Segment 2.

As shown, metadata providing a mapping of LBAs to PBAs, may be maintained for each of the data blocks. In particular, each physical block having a corresponding PBA in each of Segments 1, 2 and 3 may be referenced by LBAs. For each LBA, VSAN module 108, may store in the metadata, at least a corresponding PBA. In certain embodiments, as shown in FIG. 3B, the metadata may include an LBA to PBA mapping table storing tuples of <LBA, PBA>, where the LBA is the key (e.g., in one-layer mapping architecture). In certain embodiments where the data blocks are compressed, the logical map further includes the size of each data block compressed in sectors and a compression size. In certain other embodiments, as shown in FIG. 3C, the metadata may include an LBA to middle block address (MBA) mapping table (e.g., logical map) storing tuples of <LBA, MBA>, where the LBA is the key, and an MBA to PBA mapping table (e.g., middle map) storing tuples of <MBA, PBA>. As described in more detail below, the two-layer mapping architecture (e.g., having a logical map with LBA to MBA mappings and a middle map with MBA to PBA mappings) may be used in such embodiments to address the problem of I/O overhead when dynamically relocating physical data blocks.

As shown in FIG. 3A, Segments 1, 2, and 3 may also include a segment summary which includes metadata stored for data blocks in the corresponding segment. The segment summary may be placed at the end of the segment. In certain embodiments where one-layer mapping architecture is implemented (e.g., mapping LBAs directly to PBAs without the use of MBAs), the metadata stored for the segments in the segment summary may include LBAs for data blocks stored in the segment. In certain embodiments where two-layer mapping architecture is implemented (e.g., mapping LBAs to MBAs, which are further mapped to PBAs), as shown in FIG. 3A, the metadata stored for the segment in the segment summary may include MBAs for data blocks stored in the segment. For example, in cases where two-layer mapping architecture is used to store metadata for data blocks, in Segment 1, LBA1 is mapped to MBA1 in a logical map of the mapping architecture and MBA1 is mapped to PBA1 in a middle map of the mapping architecture. Accordingly, the segment summary stored in Segment 1 may include the MBA for LBA1, in particular, MBA1. As described in more detail below, according to aspects of the present disclosure, the metadata stored in the segment summary may be used as “expected values” when using “compare and set” and “compare and remove” APIs for determining whether metadata may be updated, prior to updating the metadata during segment cleaning.

In the example shown in FIG. 3A, data previously written to a block in Segment 1 corresponding to PBA2 is referenced by LBA3. Thus, metadata stored for this data block may be stored as a tuple of <LBA3, PBA2>. Similar tuples may be stored for other LBAs in Segments 1, 2, and 3. VSAN module 108 may use the metadata to determine which PBA is referenced by an LBA.

As discussed above, live data blocks within each of Segment 1 and Segment 2 may be taken out of their respective segments and consolidated into one segment, Segment 3. Such consolidation may include reading the data blocks of Segment 1 and Segment 2, identifying only live data blocks within each of Segment 1 and Segment 2, and moving the identified live data blocks into a write buffer such that they may be written to new physical block locations.

The dynamic relocation of live (e.g., active) data blocks to new locations may trigger updates to the metadata. For example, as shown in FIG. 3A, data block contents of LBA3, LBA9, LBA13, LBA15, and LBA19 may be collectively written to blocks of Segment 3, wherein the blocks of Segment 3 correspond to PBA11-PBA15. The original PBAs corresponding to the LBAs written to Segment 3 may be marked “stale” or “dead” following completion of the write of data to Segment 3. Additionally, the metadata may be updated to reflect the changes of the PBAs mapped to the LBAs. For example, the PBA for LBA3 may be updated from <LBA3, PBA2> to <LBA3, PBA11>, and the physical addresses corresponding to LBA9, LBA13, LBA15, and LBA19 may be updated similarly.

In certain embodiments, metadata for the data blocks may be stored as key-value pairs in a B+ tree; thus, to update the metadata to reflect the PBA changes for different LBAs, one or more key-value pairs in the B+ tree may need to be updated.

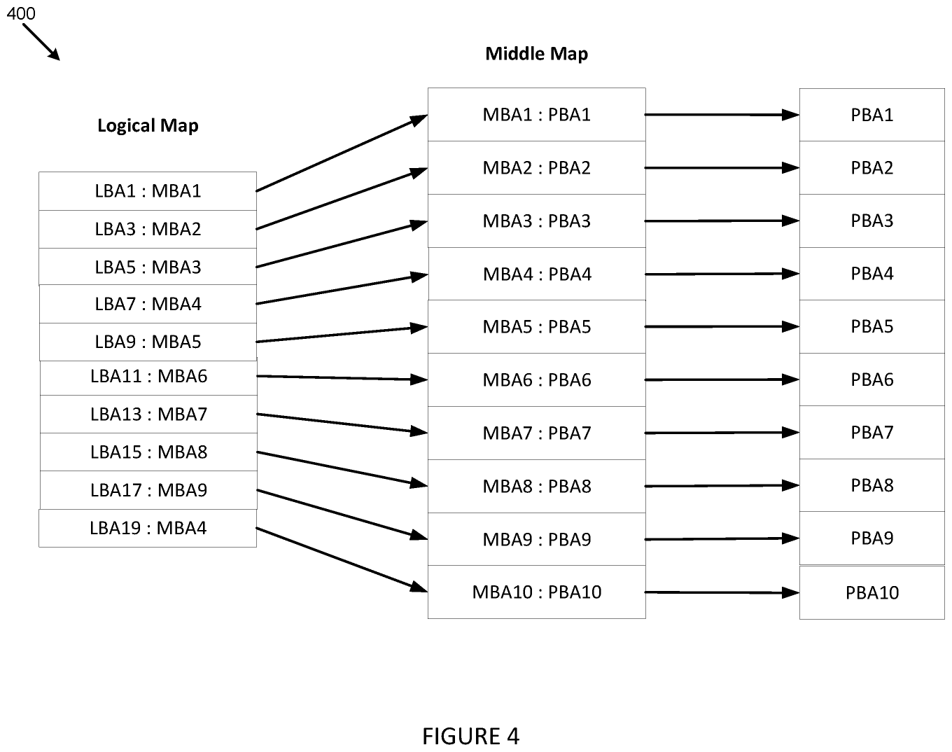

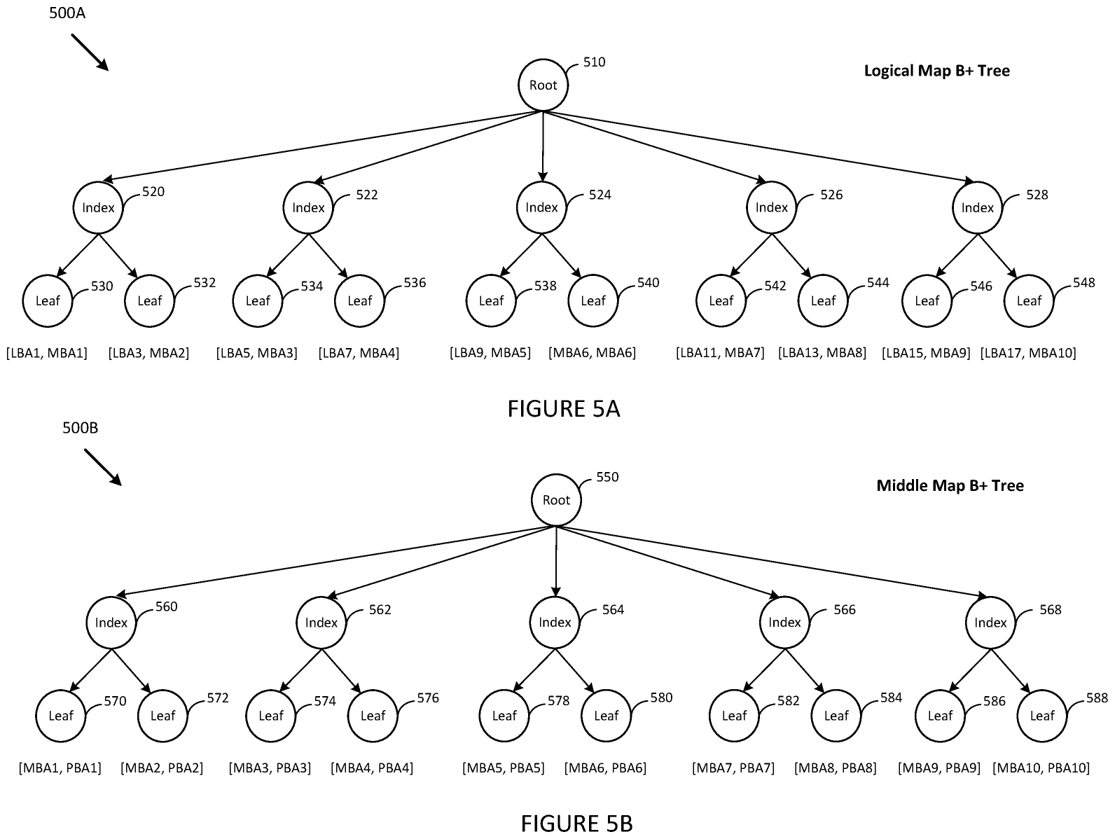

FIG. 4 is a diagram 400 illustrating example two-layer extent mapping architecture storing metadata (e.g., LBA-MBA-PBA mappings) for Segments 1 and 2 in FIG. 3A, while FIGS. 5A and 5B illustrate a B+ tree logical map and a B+ tree middle map, respectively, where such metadata is stored as key-value pairs, in accordance with certain aspects of the present disclosure.

As shown in FIG. 4, the first layer of the two-layer mapping architecture includes a logical map. The schema of the logical map may store a one tuple key <LBA> to a two-tuple value <MBA, numBlocks>. In some embodiments, other tuple values, such as a number of sectors, compression size, etc. may also be stored in the logical map. Because a middle map extent may refer to a number of contiguous blocks, value “numBlocks” may indicate a number of uncompressed contiguous middle map blocks for which the data is stored within.

The second layer of the two-layer extent mapping architecture includes a middle map responsible for maintaining a mapping between MBA(s) and PBA(s) (or physical sector address(es) (PSA(s)) of one or more sectors (e.g., each sector being 512-byte) of a physical block where blocks are compressed prior to storage). Accordingly, the schema of the middle map may store a one tuple key <MBA> and a two-tuple value <PBA, numBlocks>. Value “numBlocks” may indicate a number of contiguous blocks starting at the indicated PBA. Any subsequent overwrite may break the PBA contiguousness in the middle map extent, in which case an extent split may be triggered.

As mentioned previously, the middle map is included in the mapping architecture, such as to address the problem of I/O overhead when dynamically relocating physical data blocks during segment cleaning (e.g., for full stripe writes). In particular, where multiple LBAs map to a single PBA and data stored in the data block reference by a PBA is moved to a new data block referenced by a new PBA, for example, as a result of segment cleaning, by using the two-layer mapping architecture, only a single extent in the middle map may need to be updated to reflect the change of the PBA for all of the LBAs which reference that data block. In other words, this two-layer architecture reduces I/O overhead by not requiring the system to update multiple references to the same PBA.

In the example of FIG. 3A, prior to segment cleaning (e.g., consolidating live data blocks in Segment 3) and prior to marking data for certain data blocks in Segment 1 and Segment 2 as stale, data for LBA1 is stored at PBA1, data for LBA3 is stored at PBA2, data for LBA5 is stored at PBA3, etc. Accordingly, in the two-layer mapping architecture illustrated in FIG. 4, LBA1 is mapped to PBA1 (e.g., LBA1 is mapped to MBA1 which is mapped to PBA1), LBA3 is mapped to PBA2 (e.g., LBA3 is mapped to MBA2 which is mapped to PBA2), LBA5 is mapped to PBA3 (e.g., LBA5 is mapped to MBA3 which is mapped to PBA3), etc. In particular, LBA1 is stored in a logical map as a tuple of <LBA1, MBA1>, LBA3 is stored in the logical map as a tuple of <LBA3, MBA2>, LBA5 is stored in the logical map as a tuple of <LBA5, MBA3>, etc., where the LBA is the key. Further, MBA1 is stored in a middle map as a tuple of <MBA1, PBA1>, MBA2 is stored in the middle map as a tuple of <MBA2, PBA2>, MBA3 is stored in the middle map as a tuple of <MBA3, PBA3>, etc., where the MBA is the key Although not illustrated in FIG. 4, in some cases, one or more LBAs may point to the same MBA where data associated with those LBAs is stored in a data block referenced by the same PBA.

The logical map key-value pairs (e.g., <LBA, MBA>) may be stored in a first B+ tree 500A, as illustrated in FIG. 5A, while the middle map key-value pairs (e.g., <MBA, PBA>) may be stored in a second B+ tree 500B, as illustrated in FIG. 5B.

As illustrated, B+ tree 500A and B+ tree 500B may include a plurality of nodes connected in a branching tree structure. Each node may have one parent and two or more children.

The top node of B+ tree 500A may be referred as root node 510, which has no parent node. The middle level of B+ tree 500A includes middle nodes 520-528, which may have both parent and child nodes. The bottom level of B+ tree 500A includes leaf nodes 530-548 which do not have any more children. In the illustrated example, in total, B+ tree 500A has sixteen nodes, two levels, and a height of three. Root node 210 is in level two of the tree, middle (or index) nodes 520-528 are in level one of the tree, and leaf nodes 530-548 are in level zero of the tree.

Similarly, the top node of B+ tree 500B is root node 550, which has no parent node. The middle level of B+ tree 500B includes middle nodes 560-568, which may have both parent and child nodes. The bottom level of B+ tree 500B includes leaf nodes 570-588 which do not have any more children. In the illustrated example, in total, B+ tree 500B also has sixteen nodes, two levels, and a height of three. In the illustrated example, B+ tree 500A and B+ tree 500B have only two levels, and thus only a single middle level, but other B+ trees may have more middle levels and thus greater heights.

Each node of B+ tree 500A and 500B may store at least one tuple. In a B+ tree, leaf nodes may contain data values (or real data) and middle (or index) nodes may contain only indexing keys. For example, each of leaf nodes 530-548 in B+ tree 500A and each of leaf nodes 570-588 in B+ tree 500B may store at least one tuple that includes a key mapped to real data, or mapped to a pointer to real data, for example, stored in a memory or disk.

Accordingly, given B+ tree 500A is a B+ tree logical map, the tuples in B+ tree 500A correspond to key-value pairs of <LBA, MBA> mappings for data blocks associated with each LBA. These tuples may correspond to the LBA to MBA mappings provided in FIG. 4. Further, given B+ tree 500B is a B+ tree middle map, the tuples in B+ tree 500B correspond to key-value pairs of <MBA, PBA> mappings for data blocks associated with each MBA. These tuples may correspond to the MBA to PBA mappings provided in FIG. 4. In certain embodiments, each leaf node may also include a pointer to its sibling(s), which is not shown for simplicity of description. On the other hand, a tuple in the middle nodes and/or root nodes of B+ tree 500A and B+ tree 500B may store an indexing key and one or more pointers to its child node(s), which can be used to locate a given tuple that is stored in a child node.

As mentioned previously, one or more key-value pairs in such B+ trees may need to be updated as live data blocks are moved during segment cleaning. More specifically, as live data blocks stored at PBAs are moved to different PBAs in a new segment, the <MBA, PBA> key-value pairs stored in middle map B+ tree 500B may need to be updated (e.g., to achieve data consistency) to reflect the new PBAs. However, other source(s) of I/O may also have access to and need to read and/or modify such key-value pairs in the B+ tree. Accordingly, this may result in an undesirable race condition. Specifically, a race condition may occur when a received I/O and the segment cleaning process concurrently seek to read and/or modify the same metadata stored as key-value pairs in the B+ tree.

To avoid inconsistent or corrupt metadata as a result of such a race condition, aspects described herein propose the use of “compare and set” and “compare and remove” APIs. In particular, where “compare and set” or “compare and remove” APIs cannot confirm (1) a first value, for example, an expected value (e.g., an expected PBA) for a key (e.g., MBA) stored in B+ tree 500B for a data block matches (2) a second value, for example, a previously recorded value (e.g., a previous PBA) for the key stored within a segment, no updates to the metadata for segment cleaning may be performed, and segment cleaning processes may be retried. On the other hand, where the “compare and set” or “compare and remove” APIs are able to confirm the two values for the same key match, updates to the metadata for segment cleaning may be performed. Accordingly, race conditions may be avoided, and the integrity and consistency of metadata stored in the B+ tree may be maintained.

Further, given “compare and set” and “compare and remove” APIs described herein are used to compare values (e.g., PBAs) for a single key (e.g., MBA), only nodes in the B+ tree containing key-value pairs associated with the single key, as well as their parent node, may need to be locked. Accordingly, aspects described herein leverage granular locking of nodes in the B+ tree. Thus, I/O latency present when locking multiple nodes in the B+ tree for metadata updating may be avoided because the other nodes in the B+ tree remain unlocked and I/Os for those nodes can be processed.

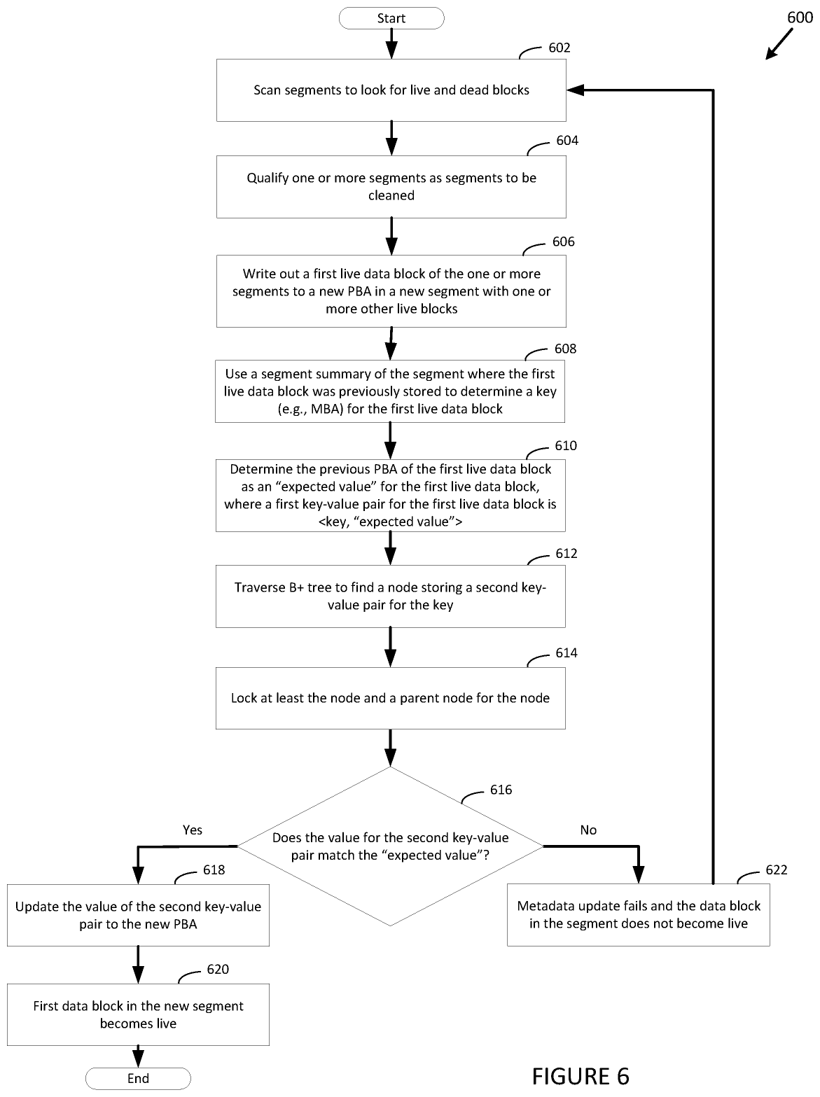

FIG. 6 is an example workflow 600 for metadata updating during segment cleaning, according to an example embodiment of the present application. Workflow 600 may be performed by segment cleaner 140, illustrated in FIG. 1, to update metadata associated with live data blocks written to new physical block locations (e.g., during segment cleaning).

For ease of illustration, workflow 600 is described with respect to example segment cleaning illustrated in FIG. 3. In particular, workflow 600 illustrates example operations for updating metadata (e.g., stored in leaf node 572 of B+ tree 500B in FIG. 5) for LBA3 (e.g., associated with MBA2) from PBA2 to PBA11, for a live data block associated with LBA3 that is moved from a data block referenced by PBA2 in Segment 1 to a data block referenced by PBA11 in Segment 3. Similar operations described in workflow 600 may also be used to update metadata for LBA9 (e.g., associated with MBAS) from PBA5 to PBA12, metadata for LBA13 (e.g., associated with MBA7) from PBA7 to PBA13, metadata for LBA15 (e.g., associated with MBA8) from PBA8 to PBA14, and metadata for LBA19 (e.g., associated with MBA10) from PBA10 to PBA15 for the example segment cleaning illustrated in FIG. 3A.

Workflow 600 begins, at operation 602, by segment cleaner 140 scanning one or more segments loaded in memory to identify blocks of each segment which are live data blocks and which are dead data blocks. At operation 604, segment cleaner 140 may qualify one or more segments, based on the scanned segments, as segments to be cleaned (e.g., segments on which to perform segment cleaning). Segment cleaner 140 may qualify a segment based on any number of factors. In certain aspects, segment cleaner 140 may qualify a segment as a segment to be cleaned based on a ratio of live data blocks to dead data blocks in the segment. In certain aspects, segment cleaner 140 may qualify a segment where a number of live data blocks in a segment is greater than a first threshold or a number of dead data blocks in a segment is lower than a second threshold.

Referring to the example segment cleaning provided in FIG. 3A, at operation 602, segment cleaner 140 scans Segment 1 and Segment 2. In Segment 1, segment cleaner 140 identifies data blocks associated with LBA3 and LBA9 as live data blocks and data blocks associated with LBA1, LBA5, and LBA7 as dead data blocks. Similarly, in Segment 2, segment cleaner 140 identifies data blocks associated with LBA13, LBA15, and LBA19 as live data blocks and data blocks associated with LBA11 and LBA17 as dead data blocks. At operation 604, segment cleaner 140 qualifies each of Segment 1 and Segment 2 as segments to be cleaned.

At operation 606, segment cleaner 140 writes out a first live data block of one or segments qualified as segments which are to be cleaned to a new PBA in a new segment with one or more other live blocks. Referring again to FIG. 3A, segment cleaner 140 may write out the live data block associated with LBA3 to a new segment, Segment 3. Accordingly, segment cleaner 140 may mark PBA2 in Segment 1 as dead, such that garbage collection may, at a later time, remove this dead data block. Segment cleaner 140 may write the live data block associated with LBA3 to a new PBA, PBA11, in Segment 3. Although segment cleaner begins, in this example, by writing out the live data block associated with LBA3, in other embodiments, segment cleaner 140 may choose a different live data block from Segment 1 or any of the live data blocks from Segment 2.

At operation 608, segment cleaner 140 uses (e.g., checks) a segment summary of the segment where the first live data block was previously stored to determine a key for the first live data block. As shown in FIG. 3A, the segment summary of Segment 1 (e.g., the segment where the data block associated with LBA3 was previously stored, prior to operation 606), segment cleaner 140 determines a key associated with the data block for LBA3 is MBA2.

At operation 610, segment cleaner 140 determines the previous PBA of the first live data block as an “expected value” for the first live data block, where a first key-value pair for the data block is <key, “expected value”>. In certain aspects, segment cleaner 140 may determine the previous PBA of the first live data block using a persistent on-disk data structure used to maintain a list of segments, as well as their associated fullness and segment offset on the disk. Segment cleaner 140 may read this data structure to determine an offset of the segment being cleaned (e.g., the segment where the live data block was previously located) and use this offset (as well as a block index of the live data block) to calculate the previous PBA of the first live data block, or the “expected value” for the first live data block. In the example illustrated in FIG. 3A, segment cleaner 140 determines the previous PBA for the data block associated with LBA3 is PBA2. Accordingly, segment cleaner 140 uses PBA2 as the “expected value” for the data block, such that a first key-value pair for the data block associated with LBA3 is <MBA2, PBA2> (e.g., where MBA2 was determined at operation 608).

At operation 612, segment cleaner 140 traverses a B+ tree to find a node storing a second-key value pair for the key. For example, segment cleaner 140 traverses example B+ tree 500B of FIG. 5 (e.g., middle map B+ tree) at operation 612, to find a node storing a second key-value pair having a key of MBA2. In the illustrated example, segment cleaner 140 may locate node 572 containing the key-value pair <MBA2, PBA2>.

To update the metadata at node 572 to reflect the change in PBA for the data block (e.g., that was moved from PBA2 to PBA11 during segment cleaning), at operation 614, B+ tree code of B+ tree 500B may determine which nodes are to be locked within B+ tree 500B. In certain aspects, segment cleaner 140 may call a “compare and set” API and provide, as input into the B+ tree code, the previous PBA of the first live data (e.g., the “expected value” of the first live data block) to trigger locking of nodes using the B+ tree code. In this example, the B+ tree code may determine to lock node 572, as well as its parent node, node 560. The locks placed on each of these nodes may be “exclusive mode” locks or “shared mode” locks.

Locking node 572 and node 560 using “exclusive mode” locks may allow the B+ tree code, on behalf of segment cleaner 140, exclusive access to each of node 572 and node 560 while the locks are set. Exclusive access given to the B+ tree code, on behalf segment cleaner 140, may help to ensure that only one source of I/O is updating the metadata at these nodes while the locks are in place. In other words, other sources of I/O may not modify the metadata at each of these nodes while the locks are in place. Further, other sources of I/O may not read the metadata stored at these nodes when “exclusive mode” locks are used. However, concurrent operations on other nodes in B+ tree 500B by other sources of I/O may occur while the locks are placed on node 572 and node 560. For example, another source of I/O seeking to modify and/or remove the metadata stored at node 574 in B+ tree 500B may access the modify the metadata stored at node 574 while the locks are placed on node 572 and node 560. Locking node 572 and node 560 using “shared mode” locks may also allow the B+ tree code, on behalf of segment cleaner 140, exclusive write access to each of node 572 and node 560 while the locks are set; however, unlike using “exclusive mode” locks, with “shared mode” locks, other sources of I/O may continue to read the metadata stored at the locked nodes. For example, with “shared mode” locks, metadata lookups may still occur for other sources of I/O. The B+ tree code may determine the appropriate nodes to lock and/or the appropriate mode for locking these nodes based on which nodes and/or which modes will guarantee the atomicity of the “compare and set” operations.

In certain aspects, the B+ tree code may determine that three nodes of the B+ tree are to be locked, at operation 614, to update metadata of the node identified at operation 612. For example, the B+ tree code may determine that three nodes are to be locked where proactive split, merge, and rebalance techniques are used for the B+ tree. In particular, proactive split, merge, and rebalance techniques may be used to balance the metadata stored in the B+ tree prior to a node becoming full. For example, to balance metadata stored in the B+ tree, a node may be proactively split or proactively merged with a second node. Such merging and splitting of nodes in the B+ tree may require parent nodes of the leaf nodes storing the key-value pairs, and in some cases sibling nodes, to be locked. Accordingly, when updating the metadata in the B+ tree, two or three nodes may be locked at a time to allow for new child nodes of a parent node to be created (e.g., until a maximum number of child nodes or a maximum fan out occurs (e.g., the number of child nodes of a node may be called “fan out”)) or existing child nodes to be merged. For example, proactive merging of child nodes may occur where key-value pairs of a node are likely to be removed, such that the node, prior to merging, will no longer be storing any key-value pairs.

As mentioned previously, granular locking (e.g., locking up to three nodes in the B+ tree) may allow for minimal or no I/O latency as compared to techniques which involve locking multiple B+ tree nodes for segment cleaning metadata updates.

At operation 616, the B+ tree code determines whether the value for the second key-value pair (e.g., the key-value pair stored at the node identified at operation 612 in the B+ tree) matches the expected value determined at operation 610 (e.g., the previous PBA of the first live data block). In the illustrated example, at operation 616, the B+ tree code determines whether PBA2 matches the value stored in key-value pair <MBA2, PBA2> stored at node 572 in the example B+ tree.

Because, at operation 616, the B+ tree code determines PBA2 matches PBA2, B+ tree code determines that another I/O had not been issued for writing, deleting, or updating the metadata for this key, MBA2, since commencing the write out of the live data block associated with LBA3 and MBA2. Accordingly, at operation 618, the B+ tree code updates the value of the second key-value pair to the new PBA. In the illustrated example, the B+ tree code updates the key-value pair <MBA2, PBA2> stored at node 572 in the example B+ tree to <MBA2, PBA11>. At operation 620, the data block associated with LBA3 in Segment 3 becomes live. Operations 616-620 may be referred to as “compare and set” operations as current values are compared with expected values, and current values are replaced with new values where the current values and the expected values match.

Alternatively, in some cases, prior to updating the metadata for MBA2 stored at node 572, but after commencing the write out of the live data block associated with LBA3 (and MBA2) to Segment 3, a user issues an I/O for writing, deleting, or updating metadata associated with LBA3. In some cases, the I/O itself may cause metadata for this data block (e.g., a key-value pair) requested to be updated, and stored in the B+ tree to be modified (e.g., the update of the stored PBA value). In some other cases, the I/O may cause a bank (e.g., bank 126 illustrated in FIGS. 1 and 2) to become full causing a flush of the data in the bank to be written to storage, and metadata for this data (e.g., stored in the B+ tree) to be modified. Accordingly, in some cases, at operation 616, the value for the second key-value pair may not match the expected value. In certain aspects, based on this mismatch, the B+ tree code may determine that an I/O, and in some cases a bank flush, occurred prior to updating the metadata for MBA2 stored at node 572, but after commencing the write out of the live data block associated with LBA3 (and MBA2) to Segment 3.

Where the values don't match, at operation 622, the metadata update fails and the data block in the segment does not become live. In particular, to cause a data block to become live, metadata needs to point to the new data block. Because metadata cannot be updated at this point (e.g., based on compare and set rules described herein), the metadata may not point to the new data block. Accordingly, the new data block may be inactive (or dead) and, at a later time, garbage collected.

After operation 622, segment cleaner 140 may attempt to again clean up segments. In certain aspects, segment cleaner 140 may again try to move the data block associated with LBA3 to a new segment and repeat operations 602-620. In certain aspects, segment cleaner 140 may realize the data block associated with LBA3 does not need to be moved to a new segment and not repeat operations 602-620 for the data block. In certain aspects, segment cleaner 140 may reattempt segment cleaning by moving a data block associated with a different LBA to a new location and repeat operations 602-620.

In certain aspects, “compare and remove” operations may be used in place of “compare and set” operations. “Compare and remove” operations may be used to compare current values with expected values and remove the current values where the current values and expected values match. Accordingly, instead of updating the value of the second key-value pair to a new PBA at operation 618, where “compare and remove” operations are used (e.g., not for segment cleaning), current values may be removed at operation 618 (e.g., where current and expected values match). “Compare and remove” operations may be used to update the metadata for purposes other than segment cleaning; thus, when “compare and remove” operations are used, operations 602-606 may be skipped.

Accordingly, aspects of the present disclosure provide techniques for achieving race free and efficient segment cleaning in a log structured file system. Such techniques may be used to maintain the correctness of user metadata stored in B+ tree data structures without locking the entire B+ tree data structure for metadata updates.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by one or more processors of a computing system, cause the computing system to perform a method, as described herein.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method of updating metadata for data blocks referenced by logical block addresses (LBAs), the method comprising:
identifying a first segment containing a first physical block corresponding to a first physical block address (PBA) where content of a first data block was previously stored;
determining a first key associated with the first data block, wherein the first key comprises a block address in a first key-value pair that maps the block address to the first PBA;
traversing a B+ tree to locate a node storing a second key-value pair that maps the first key to a second PBA;
determining the second PBA and the first PBA match; and
based on the determination that the second PBA and the first PBA match:
updating, in the second key-value pair, the second PBA to a third PBA corresponding to a second physical block where the content of the first data block is currently stored; or
removing, in the second key-value pair, the second PBA.

2. The method of claim 1, wherein the first key comprises:
an LBA associated with the first data block, wherein a logical map maintains the second key-value pair mapping the LBA to the second PBA; or
a middle block address (MBA) associated with the first data block, wherein the logical map maintains a third key-value pair mapping the LBA to the MBA and a middle map maintains the second key-value pair mapping the MBA to the second PBA.

3. The method of claim 1, further comprising:
after locating the node, locking the node and a parent node of the node prior to the:
updating the second PBA to the third PBA; or
removing the second PBA.

4. The method of claim 3, wherein other nodes in the B+ tree are not locked when the node and the parent node are locked.

5. The method of claim 3, wherein locking the node and the parent node comprises:
locking each of the node and the parent node with an exclusive lock, or
locking each of the node and the parent node with a shared lock.

6. The method of claim 1, wherein the first key associated with the first data block is determined using a segment summary contained in the first segment.

7. The method of claim 1, further comprising:
scanning the first segment containing the first physical block to identify live data blocks and dead data blocks in the first segment, wherein the first physical block is identified as a live data block;
qualifying the first segment as a segment to be cleaned based on the scanning;
writing the content of the first data block stored in the first physical block corresponding to the first PBA to the second physical block corresponding to the third PBA, the second physical block contained in a second segment; and
marking the first physical block as a dead data block.

8. The method of claim 1, further comprising:
writing content of a second data block stored in a third physical block, corresponding to a fourth PBA, to a fourth physical block, corresponding to a fifth PBA;
determining a second key associated with the second data block, wherein the second key comprises a block address in a third key-value pair that maps the block address to the fourth PBA;
traversing a B+ tree containing to locate a node storing a fourth key-value pair that maps the second key to a sixth PBA; and
determining the sixth PBA stored in the fourth key-value pair and the fourth PBA do not match, wherein based on the determination that the sixth PBA and the fourth PBA do not match, the fourth physical block, corresponding to the fifth PBA does not become live and is marked as a dead data block.

9. A system comprising:
one or more processors; and
at least one memory, the one or more processors and the at least one memory configured to cause the system to:
identify a first segment containing a first physical block corresponding to a first physical block address (PBA) where content of a first data block was previously stored;
determine a first key associated with the first data block, wherein the first key comprises a block address in a first key-value pair that maps the block address to the first PBA;
traverse a B+ tree to locate a node storing a second key-value pair that maps the first key to a second PBA;
determine the second PBA and the first PBA match; and
based on the determination that the second PBA and the first PBA match:
update, in the second key-value pair, the second PBA to a third PBA corresponding to a second physical block where the content of the first data block is currently stored; or
remove, in the second key-value pair, the second PBA.

10. The system of claim 9, wherein the first key comprises:
an LBA associated with the first data block, wherein a logical map maintains the second key-value pair mapping the LBA to the second PBA; or
a middle block address (MBA) associated with the first data block, wherein the logical map maintains a third key-value pair mapping the LBA to the MBA and a middle map maintains the second key-value pair mapping the MBA to the second PBA.

11. The system of claim 9, wherein the one or more processors and the at least one memory are further configured to cause the system to:
after locating the node, locking the node and a parent node of the node prior to the:
updating the second PBA to the third PBA; or
removing the second PBA.

12. The system of claim 11, wherein other nodes in the B+ tree are not locked when the node and the parent node are locked.

13. The system of claim 11, wherein the one or more processors and the at least one memory are configured to cause the system to lock the node and the parent node by:
locking each of the node and the parent node with an exclusive lock, or
locking each of the node and the parent node with a shared lock.

14. The system of claim 9, wherein the first key associated with the first data block is determined using a segment summary contained in the first segment.

15. The system of claim 9, wherein the one or more processors and the at least one memory are further configured to cause the system to:
scan the first segment containing the first physical block to identify live data blocks and dead data blocks in the first segment, wherein the first physical block is identified as a live data block;
qualify the first segment as a segment to be cleaned based on the scanning;
write the content of the first data block stored in the first physical block corresponding to the first PBA to the second physical block corresponding to the third PBA, the second physical block contained in a second segment; and
mark the first physical block as a dead data block.

16. The system of claim 9, wherein the one or more processors and the at least one memory are further configured to cause the system to:
write content of a second data block stored in a third physical block, corresponding to a fourth PBA, to a fourth physical block, corresponding to a fifth PBA;
determine a second key associated with the second data block, wherein the second key comprises a block address in a third key-value pair that maps the block address to the fourth PBA;
traverse a B+ tree containing to locate a node storing a fourth key-value pair that maps the second key to a sixth PBA; and
determine the sixth PBA stored in the fourth key-value pair and the fourth PBA do not match, wherein based on the determination that the sixth PBA and the fourth PBA do not match, the fourth physical block, corresponding to the fifth PBA does not become live and is marked as a dead data block.

17. A non-transitory computer-readable medium comprising instructions that, when executed by one or more processors of a computing system, cause the computing system to perform operations for updating metadata for data blocks referenced by logical block addresses (LBAs), the operations comprising:
identifying a first segment containing a first physical block corresponding to a first physical block address (PBA) where content of a first data block was previously stored;
determining a first key associated with the first data block, wherein the first key comprises a block address in a first key-value pair that maps the block address to the first PBA;
traversing a B+ tree to locate a node storing a second key-value pair that maps the first key to a second PBA;
determining the second PBA and the first PBA match; and
based on the determination that the second PBA and the first PBA match:
updating, in the second key-value pair, the second PBA to a third PBA corresponding to a second physical block where the content of the first data block is currently stored; or
removing, in the second key-value pair, the second PBA.

18. The non-transitory computer-readable medium of claim 17, wherein the first key comprises:
an LBA associated with the first data block, wherein a logical map maintains the second key-value pair mapping the LBA to the second PBA; or
a middle block address (MBA) associated with the first data block, wherein the logical map maintains a third key-value pair mapping the LBA to the MBA and a middle map maintains the second key-value pair mapping the MBA to the second PBA.

19. The non-transitory computer-readable medium of claim 17, wherein the operations further comprise:
after locating the node, locking the node and a parent node of the node prior to the:
updating the second PBA to the third PBA; or
removing the second PBA.

20. The non-transitory computer-readable medium of claim 19, wherein other nodes in the B+ tree are not locked when the node and the parent node are locked.
